(19) United States
(12) Patent Application Publication
(10) Pub. No.: US 2014/0009926 A1
(43) Pub. Date: Jan. 9, 2014

(54) POWER SUPPLY ASSEMBLY FOR LED-BASED LIGHT TUBE

(71) Applicant: iLumisys, Inc., Troy, MI (US)

(72) Inventors: David L. Simon, Grosse Pointe Woods, MI (US); John Ivey, Farmington Hills, MI (US); James Amrine, Ann Arbor, MI (US); Ryan Meganck, Troy, MI (US)

(21) Appl. No.: 13/935,592

(22) Filed: Jul. 5, 2013

Related U.S. Application Data
(60) Provisional application No. 61/668,720, filed on Jul. 6, 2012.

(51) Int. Cl. F21S 4/00

(52) U.S. Cl. CPC F21S 4/008
USPC 362/222; 362/217.13

(57) ABSTRACT

An LED-based light for replacing a fluorescent light in a light fixture comprises: an elongate housing, the housing having a first longitudinal portion with a first cross section and a second longitudinal portion adjoining the first longitudinal portion with a second cross section, wherein a shape of the first cross section is different from a shape of the second cross section, such that the housing includes at least one geometric asymmetry; at least one LED arranged in the housing; and a connector at and end of the housing configured for connection to a light fixture.

### CROSS REFERENCE TO RELATED APPLICATION

This application claims priority benefit to U.S. Provisional Patent Application No. 61/668,720 filed Jul. 6, 2012, the contents of which is hereby incorporated by reference in its entirety.

### TECHNICAL FIELD

The embodiments disclosed herein relate in general to a light emitting diode (LED)-based light for replacing a conventional light in a standard fluorescent light fixture, and in particular to an LED-based light including a power supply assembly.

### BACKGROUND

Fluorescent lights may be used in a variety of locations, such as schools and commercial buildings and residential dwellings. Although fluorescent lights may have certain advantages over, for example, incandescent lights, they may also pose certain disadvantages including, inter alia, disposal problems due to the presence of potentially toxic materials within the light.

LED-based lights designed as one-for-one replacements for fluorescent tube lights have appeared in recent years. These LED-based lights can define a housing that includes circuitry configured to condition power received from a power supply to a power usable to operate the LEDs of the LED-based light.

### SUMMARY

Disclosed herein are embodiments of LED-based lights. In one aspect, an LED-based light for replacing a fluorescent light in a light fixture comprises: an elongate housing, the housing having a first longitudinal portion with a first cross section and a second longitudinal portion adjoining the first longitudinal portion with a second cross section, wherein a shape of the first cross section is different from a shape of the second cross section, such that the housing includes at least one geometric asymmetry; at least one LED arranged in the housing; and a connector at and end of the housing configured for connection to a light fixture.

In another aspect, an LED-based light for replacing a fluorescent light in a light fixture comprises: an elongate base defining a first surface and an opposing second surface; an LED circuit board supported on the first surface of the base, the LED circuit board including at least one LED; a light transmitting lens attached to the base to enclose the LED-circuit board, the lens extending a substantial length of the base; a power supply circuit board located adjacent the second surface of the base, the power supply circuit board configured to supply power to the at least one LED; and a cover attached to the base to enclose the power supply circuit board, the cover extending only a partial length of the base.

In yet another aspect, an LED-based light for replacing a fluorescent light in a light fixture comprises: an elongate base; an LED circuit board supported on the base, the LED circuit board including at least one LED; a light transmitting lens attached to the base to enclose the LED-circuit board; and a power supply assembly selectively removably attached to the base, the power supply assembly including power supply circuitry configured to supply power to the at least one LED.

These and other aspects will be described in additional detail below.

### BRIEF DESCRIPTION OF THE DRAWINGS

The various features, advantages and other uses of the present apparatus will become more apparent by referring to the following detailed description and drawings in which:

FIG. 1 is a side plan view of an exemplary LED-based light;

FIG. 2 is a partial perspective view of the LED-based light of FIG. 1;

FIGS. 3 and 4 are section views of the LED-based light of FIG. 1; and

FIG. 5 is an exploded partial perspective view of the LED-based light of FIG. 1 showing a power supply assembly.

### DETAILED DESCRIPTION

The embodiments of an LED-based light described herein include a unique housing configuration and a novel power supply assembly configured to condition a power received from a power supply to a power usable to operate the LEDs of the LED-based light.

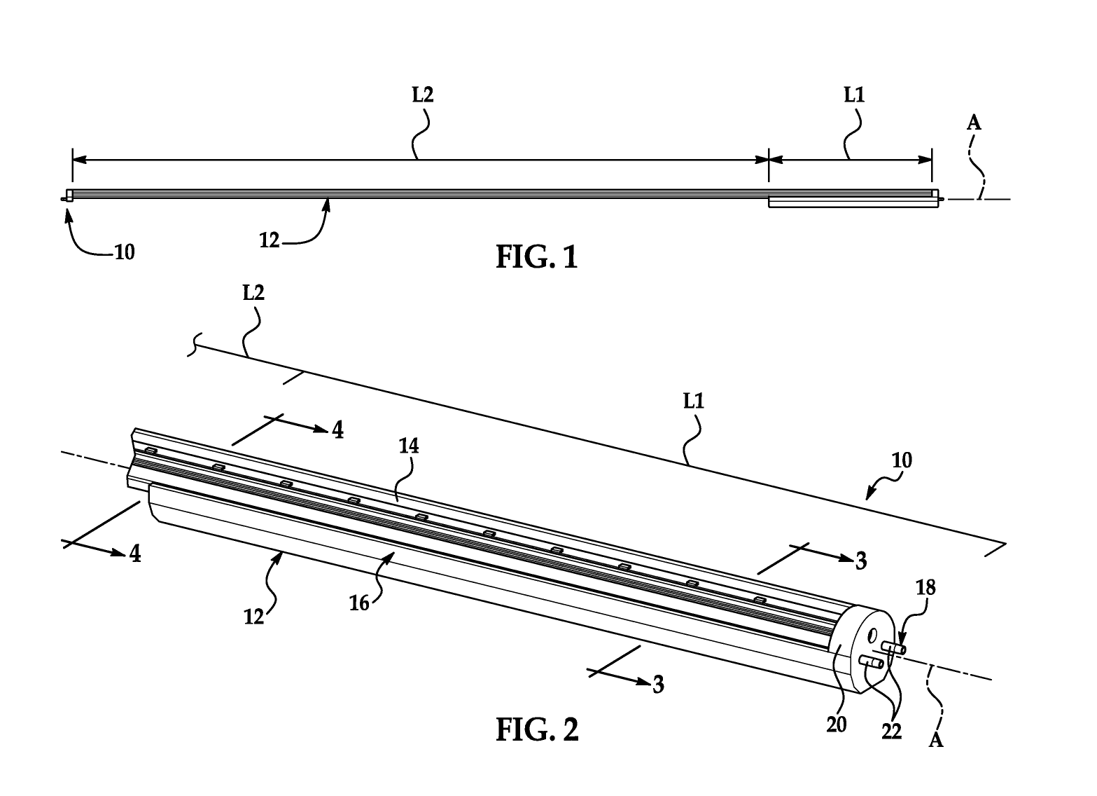

FIG. 1 illustrates an exemplary LED-based light 10 for replacing a conventional light in a light fixture. The light fixture can be designed to accept conventional fluorescent lights, such as T5, T8 or T12 fluorescent tube lights, or can be designed to accept non-standard fluorescent lights, such as lights installed by an electrician. The fixture can connect to a power source, and may include a ballast electrically connected between the power source and LED-based light 10.

A perimeter boundary of the LED-based light 10 defines a housing 12 for housing components of the LED-based light 10. The illustrated housing 12 is an elongated housing extending along a longitudinal axis A of the LED-based light 10. Although the housing 12 is illustrated as an elongated linear housing extending along a linear longitudinal axis A, housings having alternative longitudinal shapes, e.g., U-shaped or circular shaped housings, can alternatively be used. The LED-based light 10 can have any suitable length. For example, the LED-based light 10 may be approximately 48″ long, and the housing 12 can have a 0.625″, 1.0″ or 1.5″ diameter for engagement with a standard fluorescent light fixture.

The housing 12 can have one or more cross sectional shapes. For example, cylindrical, square, triangular, polygonal, or other cross sectional shapes can be used for the housing 12. The housing 12 can have a uniform lengthwise cross sectional shape, or as shown in FIG. 1, the housing 12 can have a cross sectional shape that varies at different points along the longitudinal axis A.

The housing 12 of the LED-based light 10 generally extends a length along the longitudinal axis A, and can include multiple partial lengths, for example, a first partial length L1 and a second partial length L2. In the illustrated the housing 12, each of the partial lengths L1 and L2 includes at least one portion with a cross sectional shape different from the cross sectional shape of a portion of an adjoining partial length. For example, the housing 12 of the LED-based light 10 shown in FIG. 1 generally extends a length along the longitudinal axis A, with the first partial length L1 of the housing 12 having a first cross sectional shape, and with the second partial length L2 of the housing 12 having a second cross sectional shape different from the first cross sectional shape. In the illustrated exemplary implementation of the LED-based light 10, the housing 12 has two partial lengths L1 and L2, with each of the illustrated partial lengths L1 and L2 of the housing 12 being continuous along the longitudinal axis A and having substantially constant respective cross sectional shapes. In addition, the illustrated partial lengths L1 and L2 adjoin each other to substantially extend an entire length of the housing 12. However, the housing 12 could have multiple other partial lengths, each having a portion with a differing cross sectional shape as compared to one or more respective adjoining partial lengths. In addition, the partial lengths need not be discrete, with constant cross sectional shapes. For example, the cross sectional shapes of one or more partial lengths of the housing 12 could be continuously variable.

The LED-based light 10, having a housing 12 with a cross sectional shape that varies at different points along the longitudinal axis A, can define one or more asymmetries. For example, the housing 12 shown in FIG. 1 is asymmetric about an imaginary plane normal to the longitudinal axis A of the housing 12 and positioned approximate a midpoint of the length of the housing 12. Depending upon its configuration, the housing 12 having a cross sectional shape that varies at different points along its longitudinal axis A could alternatively be symmetric about the above described imaginary plane but include one or more other geometric asymmetries. However, the housing 12 could also generally be geometrically symmetrical.

The housing 12 of the LED-based light 10 can at least partially be defined by an exterior part of a light transmitting portion. For example, with reference to FIG. 2, the housing 12 of the LED-based light 10 is at least partially defined by the exterior of a high dielectric light transmitting lens 14. The lens 14 can be made from polycarbonate, acrylic, glass or other light transmitting material (i.e., the lens 14 can be transparent or translucent). The term “lens” as used herein means a light transmitting structure, and not necessarily a structure for concentrating or diverging light.

The LED-based light 10 can include features for uniformly distributing light to an environment to be illuminated in order to replicate the uniform light distribution of a conventional fluorescent light. For example, the lens 14 can be manufactured to include light diffracting structures, such as ridges, dots, bumps, dimples or other uneven surfaces formed on an interior or exterior of the lens 14. The light diffracting structures can be formed integrally with the lens 14, for example, by molding or extruding, or the structures can be formed in a separate manufacturing step such as surface roughening. In addition to or as an alternative to light diffracting structures, a light diffracting film can be applied to the exterior of the lens 14 or placed in the housing 12, or, the material from which the lens 14 is formed can include light refracting particles. For example, the lens 14 can be made from a composite, such as polycarbonate, with particles of a light refracting material interspersed in the polycarbonate. In other embodiments, the LED-based light 10 may not include any light diffracting structures or film.

The housing 12 of the LED-based light 10 is at least partially defined by the exterior of the lens 14. The remainder of the housing 12 can generally be defined by the exterior of a lower portion 16 positioned opposite the lens 14. The lower portion 16 could be integral with the lens 14. For example, the housing 12 could include a light transmitting tube at least partially defined by the lens 14 and at least partially defined by a lower portion 16. The housing 12 may be formed by attaching multiple individual parts, not all of which need be light transmitting. For example, the housing 12 may be formed by attaching the lens 14 to an opaque lower portion 16. The lower portion 16 could be formed from a single part, or, as described below, can be formed from multiple parts that collectively partially define the housing 12.

With continued reference to FIG. 2, the LED-based light 10 can include an electrical connector 18 positioned at an end of the housing 12. In the illustrated example, the electrical connector 18 is a bi-pin connector carried by an end cap 20. A pair of end caps 20 can be attached at opposing longitudinal ends of the housing 12 for physically connecting the LED-based light 10 to a fluorescent light fixture. The end caps 20 can be the sole physical connection between the LED-based light 10 and the fixture. At least one of the end caps 20 can additionally electrically connect the LED-based light 10 to the fixture to provide power to the LED-based light 10. Each end cap 20 can include two pins 22. Two of the total four pins may be configured as bi-pin electrical connector 18 and the other two pins can be “dummy pins” that provide physical but not electrical connection to the fixture. Bi-pin electrical connector 18 is compatible with variously configured fluorescent fixtures, although other types of electrical connectors can be used, such as single pin connector or screw type connector.

The housing 12 of the LED-based light 10 is generally defined by the lens 14 and the lower portion 16 opposing the lens 14 as it extends a length along the longitudinal axis A. The cross section of the housing 12 at a point along the longitudinal axis A is likewise circumferentially defined by the lens 14 and the lower portion 16 opposing the lens 14. The housing 12 can have a cross sectional shape that varies at different points along the longitudinal axis A. For example, the housing 12 may include the lens 14 having a generally constant outer profile extending along the longitudinal axis A, and the lower portion 16 having a cross sectional shape that varies along the longitudinal axis A, such that the housing 12, circumferentially defined partially by the lens 14 and partially by the lower portion 16 opposing the lens 14, is an elongated housing 12 having a varying cross section along the longitudinal axis A.

Other configurations for the lens 14 and/or lower portion 16 could be used to define the housing 12. For example, the lens 14 could have a cross sectional shape that varies along the longitudinal axis A, with the lower portion 16 having a generally constant cross sectional shape along the longitudinal axis A. Or, both the lens 14 and the lower portion 16 could have cross sectional shapes that vary along the longitudinal axis A. Alternatively, the housing 12 could include components other than lens 14 and the lower portion 16 that function to define, either alone or in some combination with the lens 14 and/or lower portion 16, a housing 12 with a cross sectional shape that varies at different points along the longitudinal axis A.

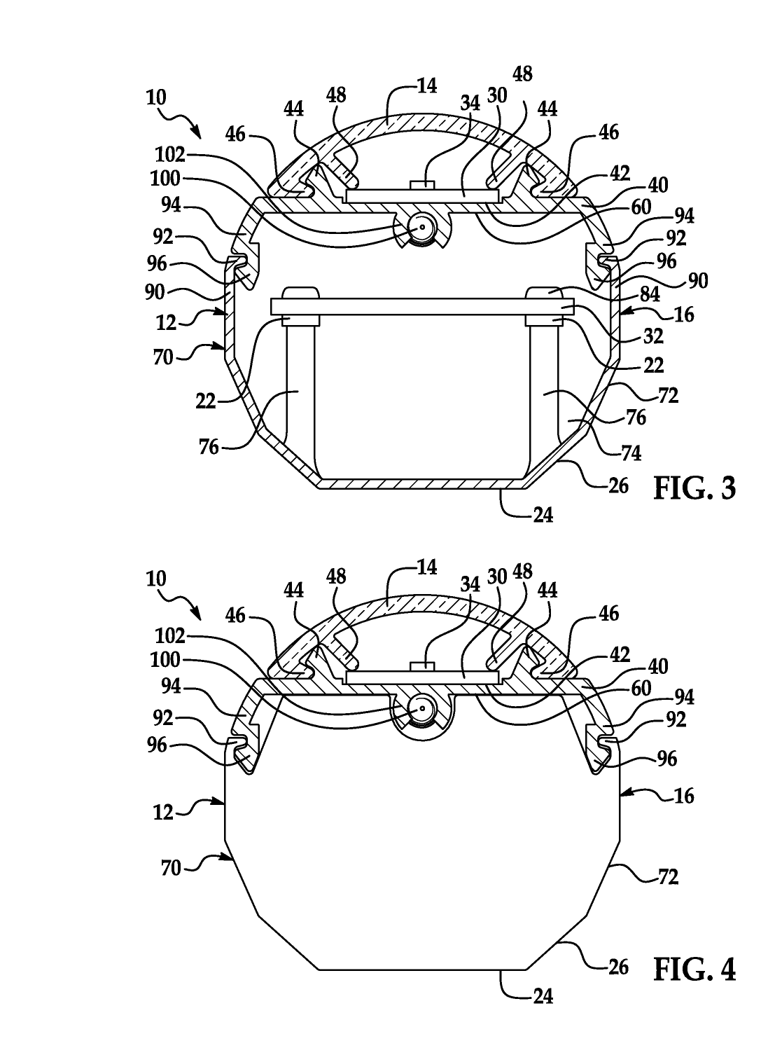

Exemplary cross sections of the housing 12 along the longitudinal axis A are illustrated in FIGS. 3 and 4. The cross section of the LED-based light 10 at a portion along the first partial length L1 of the housing 12 is taken along the line 3-3 of FIG. 2 and illustrated in FIG. 3. As illustrated in FIG. 3, along the first partial length L1, the lens 14 has an arcuate cross section, and the lower portion 16 opposing the lens 14 has a substantially C-shaped cross section, such that that the housing 12 has a substantially circular cross section along the first partial length L1 of the housing 12. The substantially circular cross section could be curvilinear, or as shown in FIG. 3, could be defined by the housing 12 including one or more flat surfaces, for instance, a number of adjoining flat longitudinally extending surfaces, such as the exemplary surfaces 24 and 26.

The cross section of the LED-based light 10 at a portion along the second partial length L2 of the housing 12 is taken along the line 4-4 of FIG. 2 and illustrated in FIG. 4. As shown in FIG. 4, the cross section of the housing 12 along the second partial length L2 is different from the cross section of the housing 12 along the first partial length L1. That is, while the housing 12 has a substantially circular cross section along the first partial length L1, the housing 12 has a non-circular cross section along the second partial length L2. The illustrated lens 14 has a generally constant arcuate cross section along the length of the housing 12, including both the first partial length L1 and second partial length L2. Along the second partial length L2, the lower portion 16 opposing the arcuate lens 14 has a substantially flat cross section, such that that the housing 12 has a generally bow-shaped cross section along the second partial length L2 of the housing 12.

With reference to FIGS. 3-5, the housing 12 of the LED-based light 10 can house a number of components. For example, one or more circuit boards 30 and 32 are illustrated as supported within the housing 12. The circuit board 30 can be an LED circuit board having at least one LED circuit. The LED circuit board 30 can include at least one LED 34, a plurality of series-connected or parallel-connected LEDs 34, an array of LEDs 34 or any other arrangement of LEDs 34. Each of the LEDs 34 can include a single diode or multiple diodes, such as a package of diodes producing light that may appear to an ordinary observer as coming from a single source. The LEDs 34 can be surface-mount devices of a type available from Nichia, although other types of LEDs can alternatively be used. For example, the LED-based light 10 can include high-brightness semiconductor LEDs, organic light emitting diodes (OLEDs), semiconductor dies that produce light in response to current, light emitting polymers, electro-luminescent strips (EL) or the like.

The LEDs 34 may emit white light or light having a range of wavelengths. LEDs that emit blue light, ultra-violet light or other wavelengths of light can be used in place of or in combination with white light emitting LEDs 34. The number, spacing and orientation of the LEDs 34 can be a function of a length of the LED-based light 10, a desired lumen output of the LED-based light 10, the wattage of the LEDs 34 and/or the viewing angle of the LEDs 34. For a 48″ LED-based light 10, for example, the number of LEDs 34 may vary from about thirty to sixty such that the LED-based light 10 outputs approximately 3,000 lumens. However, a different number of LEDs 34 can alternatively be used, and the LED-based light 10 can output any other amount of lumens. The LEDs 34 can be evenly spaced along the LED circuit board 30 and arranged on the LED circuit board 30 to substantially fill a space along a length of the lens 14 between end caps 20 positioned at opposing longitudinal ends of the housing 12. Alternatively, single or multiple LEDs 34 can be located at one or both ends of the LED-based light 10. The LEDs 34 can be arranged in a single longitudinally extending row along a central portion of the LED circuit board 30, for example, as shown in FIG. 2, or can be arranged in a plurality of rows or arranged in groups. The spacing of the LEDs 34 can be determined based on, for example, the light distribution of each LED 34 and the number of LEDs 34.

The circuit board 32 can be a power supply circuit board. The power supply circuit board 32 has power supply circuitry configured to condition an input power received from, for example, the fixture through the electrical connector 18 to a power usable by and suitable for the LEDs 34. In some implementations, the power supply circuit board 32 can include one or more of an inrush protection circuit, a surge suppressor circuit, a noise filter circuit, a rectifier circuit, a main filter circuit, a current regulator circuit and a shunt voltage regulator circuit. The power supply circuit board 32 can be suitably designed to receive a wide range of currents and/or voltages from a power source and convert them to a power usable by the LEDs 34.

The LED circuit board 30 and the power supply circuit board 32 are illustrated as elongate printed circuit boards. Multiple circuit board sections can be joined by bridge connectors to create the circuit boards 30 and 32. Also, other types of circuit boards may be used, such as a metal core circuit board. Or, instead of the circuit boards 30 and 32, other types of electrical connections (e.g., wires) can be used to electrically connect the LEDs 34 to a power source.

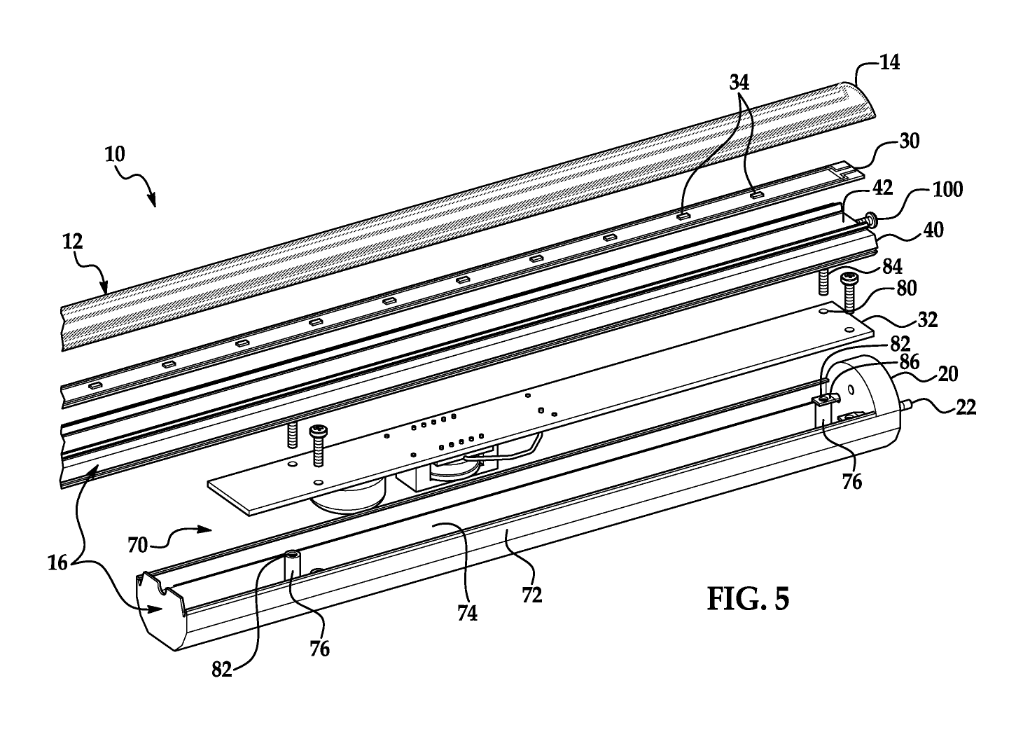

Both the LED circuit board 30 and the power supply circuit board 32 can be positioned to extend along the longitudinal axis A of the LED-based light 10. With continued reference to FIG. 5, the LED circuit board 30 can have a length different from a length of the power supply circuit board 32. For example, the LED circuit board 30 can generally extend the length of the housing 12, and the power supply circuit board 32 can extend a partial length of the housing 12, for instance, the first partial length L1 of the housing 12.

The LED circuit board 30 may be a separate component from the power supply circuit board 32, and the LED circuit board 30 can be housed separately from the power supply circuit board 32. The LED circuit board 30 is positioned adjacent the lens 14, such that the LEDs 34 included in the LED circuit board 30 are oriented to illuminate the lens 14. The power supply circuit board 32 can be housed elsewhere within the housing 12 of the LED-based light 10, for example, within a cavity defined by the lower portion 16.

The LED-based light 10 can include features for supporting the circuit boards 30 and 32 within the housing 12, and/or for supporting other components of the LED-based light 10. For example, the LED-based light 10 can include an elongate base 40. The elongate base 40 can extend the length of the housing 12 and include an LED mounting surface 42 for supporting the LED circuit board 30 within the housing 12 adjacent the lens 14. The LED mounting surface 42 may be substantially flat, so as to engage a flat underside of the LED circuit board 30 opposite the LEDs 34.

The elongate base 40 can be further configured for attachment with the lens 14. For example, the elongate base 40 may include a pair of hooked projections 44 for retaining a corresponding pair of respective projections 46 of the lens 14. The projections 46 of the lens 14 can be slidably engaged with the hooked projections 44 of the elongate base 40, or can be snap fit to the hooked projections 44. The hooked projections 44 can be formed integrally with the elongate base 40 by, for example, extruding the elongate base 40 to include the hooked projections 44. Similarly, the projections 46 can be formed integrally with the lens 14 by, for example, extruding the lens 14 to include the projections 46. The hooked projections 44 and projections 46 can extend the longitudinal lengths of the elongate base 40 and the lens 14, respectively, although a number of discrete hooked projections 44 and/or projections 46 could be used to couple the lens 14 to the elongate base 40. Alternatively, the elongate base 40 could be otherwise configured for attachment with the lens 14. For example, the lens 14 could be clipped, adhered, snap- or friction-fit, screwed or otherwise attached to the elongate base 40.

The lens 14 can include one or more structures for securing the LED circuit board 30 within the housing 12 of the LED-based light 10. For example, lens 14 may include tabs 48 for securing the LED circuit board 30 to the LED mounting surface 42 of the elongate base 40. The tabs 48 are illustrated as projecting from the lens 14 at an angle towards the LED circuit board 30 to contact the LED circuit board 30 along its longitudinal length and prevent disengagement of the LED circuit board 30 from the LED mounting surface 42. The tabs 48 can be formed integrally with the lens 14 by, for example, extruding the lens 14 to include the tabs 48. Each of the tabs 48 can extend a longitudinal length of the lens 14, although a number of discrete tabs 48 could be included along the longitudinal length of the lens 14 to secure the LED circuit board 30 to the LED mounting surface 42 of the elongate base 40. Although the tabs 48 are illustrated as projecting at an angle from the lens 14, the tabs 48 could alternatively project at other angles and/or from other structures within the LED-based light 10, for example from the elongate base 40. In addition to or as an alternative to the tabs 48, the LED circuit board 30 could be secured within the housing 12 through slidable engagement with one or more structures of the LED-based light 10, such as the end cap 20, or the LED circuit board 30 could alternatively be clipped, adhered, snap- or friction-fit, screwed or otherwise secured within the housing 12.

The illustrated elongate base 40 further includes a surface 60 opposite the LED mounting surface 42 and opposing the lens 14. The surface 60 is shown as a substantially flat surface, but could have other geometries, and can include structures for coupling with other components of the LED-based light 10. The surface 60 may form a part of the lower portion 16 of the housing 12 for the LED-based light 10 along a partial length of the housing 12. For example, the surface 60 can form a part of the lower portion 16 of the housing 12 along the second partial length L2 of the housing 12. When the surface 60 of the elongate base 40 is positioned to oppose the lens 14 with a substantially arcuate cross section, the housing 12 has the generally bow-shaped cross section shown in FIG. 4 along the second partial length L2.

The LED-based light 10 can include one or more highly thermally conductive structures for enhancing heat dissipation. For instance, the elongate base 40 could be configured as a heat sink. The elongate base 40 can be constructed from a thermally conductive material for thermally coupling the LEDs 34 to an ambient environment surrounding the LED-based light 10. The elongate base 40 may form the LED mounting surface 42, which can be configured for thermal coupling to the LEDs 34. In the LED-based light 10, for example, the LED mounting surface 42 is thermally coupled to the LEDs 34 through the LED circuit board 30, although the LEDs 34 could be otherwise thermally coupled to the LED mounting surface 42. The LED mounting surface 42 may be substantially flat, so as to engage a flat underside of the LED circuit board 30 in a thermally conductive relation. The elongate base 40 can define a heat transfer path from the LED mounting surface 42 to the surface 60, which can be configured as a heat dissipating surface for dissipating heat generated by the LEDs 34 during operation to the ambient environment surrounding the LED-based light 10. The surface 60 may be the substantially flat surface 60, although the surface 60 could alternatively include other geometries and/or structures for increasing the surface area of the surface 60, such as bends, fins or other projections.

The elongate base 40 can also be configured to support the power supply circuit board 32 within the housing 12 of the LED-based light 10. For example, the elongate base 40 of the LED-based light 10 can be configured for attachment to a power supply assembly 70 including the power supply circuit board 32. The power supply assembly 70 may generally include power supply circuitry configured to condition an input power received from a fixture or other power supply to a power usable to operate the LEDs 34. The power supply circuitry for the LED-based light 10 may be included in the power supply circuit board 32.

The power supply assembly 70 may include a cover 72 for housing and enclosing the power supply circuit board 32. The cover 72 defines a hollow cavity 74 for housing the power supply circuit board 32, and can be configured to support the power supply circuit board 32 within the cavity 74. In addition, the cover 72 can include structures for selectively and/or releasably attaching the power supply circuit board 32 to the cover 72. Various means of attachment can be used for selectively and/or releasably attaching the power supply circuit board 32 to the cover 72. In the illustrated example, the cover 72 includes a plurality of posts 76 generally forming a platform for supporting the power supply circuit board 32 within the cavity 74 of the cover 72. The power supply circuit board 32 can define one or more apertures 80 positioned for alignment with corresponding apertures 82 defined by the post (one representative aperture 80 and one representative aperture 82 are indicated with respective reference numerals). The apertures 80 are defined adjacent corners of the power supply circuit board 32, but could be positioned elsewhere on the power supply circuit board 32. The apertures 80 defined by the power supply circuit board 32 can be sized to receive a threaded fastener 84, and the apertures 82 defined by the posts 76 can be configured for threadedly receiving the threaded fastener 84 to attach the power supply circuit board 32 to the cover 72. The power supply circuit board 32 could alternatively be supported within the cover 72 through slidable engagement with a part of the cover 72, or the power supply circuit board 32 could be clipped, adhered, snap- or friction-fit, screwed or otherwise coupled to the cover 72.

The power supply assembly 70 can also include an electrical connection to electrically couple the power supply circuit board 32 to the electrical connector 18 (see for example, FIG. 2) configured to electrically connect the LED-based light 10 to a fixture in order to provide power to the LED-based light 10. For example, one or more of the threaded fasteners 84 adjacent an end cap 20 can be electrically conductive and be used to provide an electrical connection between the power supply circuitry included in the power supply circuit board 32 and one or more of the pins 22 of the end cap 20. Referring to FIG. 5, two pins 22 extend through the end cap 20 to the hollow cavity 74 enclosed by the cover 72. The portion of the pins 22 extending through the end cap 20 can define pin apertures 86 positioned generally in alignment with corresponding apertures 80 and 82 respectively defined by the power supply circuit board 32 and the posts 76. Each of the pin apertures 86 can be sized to receive a threaded fastener 84. Further, the pin apertures 86 and the apertures 80 defined by the power supply circuit board 32 can be sized to engage the threaded fastener 84 in electrically conductive relation, such that a pin 22 and the power supply circuitry include in the power supply circuit board 32 are electrically connected through the threaded fastener 84.

The power supply assembly 70 could be included in the LED-based light 10 by integrally forming the cover 72 with the elongate base 40, for example. In the illustrated exemplary implementation of the LED-based light 10, the power supply assembly 70 is releasably coupled to the LED-based light 10. The power supply assembly 70 may be a modular component that can be selectively and releasably attached to the LED-based light 10.

The cover 72 of the power supply assembly 70 may be configured for selective and releasable attachment to the elongate base 40 of the LED-based light 10. The cover 72 may be generally C-shaped, with opposing longitudinally extending side walls 90 terminating at a respective pair of terminal edges forming projections 92. The surface 60 of the elongate base 40 may include a pair of opposing flanges 94 extending from the longitudinal edges of the surface 60 in a direction away from the lens 14, and each flange 94 forms a hooked projection 96 for retaining a corresponding projection 92 of the cover 72. The projections 92 of the cover 72 can be slidably engaged with the hooked projections 96 of the elongate base 40, or can be snap fit to the hooked projections 96. The hooked projections 96 can be formed integrally with the elongate base 40 by, for example, extruding the elongate base 40 to include the flanges 94 with hooked projections 96. Similarly, the projections 92 can be formed integrally with the cover 72 by, for example, extruding the cover 72 to include the projections 92. The hooked projections 96 and projections 92 can extend the longitudinal lengths of the elongate base 40 and the cover 72, respectively, although a number of discrete hooked projections 96 and/or projections 72 could be used to couple the cover 72 to the elongate base 40. Alternatively, the cover 72 could be otherwise configured for attachment to the elongate base 40. For example, the cover 72 could be configured to be clipped, adhered, snap- or friction-fit, screwed or otherwise attached to the elongate base 40.

The cover 72 can be enclosed at each longitudinal end. For example, the cover 72 may be enclosed at a longitudinal end adjacent a longitudinal end of the housing 12 by the end cap 20. The cover 72 can be integral with the end cap 20, or the cover 72 and the end cap 20 could be separate components, with a longitudinal end of the cover 72 sized to abut the end cap 20. The illustrated end cap 20 can be affixed to the housing 12 by threadedly engaging a threaded fastener 100 through the end cap 20 and into a groove 102 formed in the elongate base 40. The groove 102 extends from the surface 60 of the elongate base 40, but could alternatively extend from other portions of the elongate base 40 or from other components of the housing 12. The end cap 20 could alternatively be clipped, adhered, snap- or friction-fit, screwed or otherwise attached to the elongate base 40. The illustrated cover 72 is integral with the end cap 20, and affixation of the end cap 20 to the elongate base 40 secures the cover 72 to the LED-based light 10.

The elongate base 40 includes the surface 60, which may form at least a part of the lower portion 16 of the housing 12 of the LED-based light 10. Absent attachment of the power supply assembly 70, for example, the surface 60 could form substantially the entire lower portion 16 of the housing 12, such that the cross section of the housing 12 is generally defined by the lens 14 and by the surface 60 of the elongate base 40 positioned to oppose the lens 14. When attached to the elongate base 40, the cover 72 of the power supply assembly 70 encloses a part of the surface 60 of the elongate base 40 to form at least a part of the lower portion 16 of the housing 12. When attached to the elongate base 40 in this manner, the cross section of the housing 12 along the length of the cover 72 is generally defined by the lens 14 and by the cover 72 positioned to oppose the lens 14. The cover 72 may extend the first partial length L1 of the housing 12, such that the lower portion 16 of the housing 12 is defined by the lens 14 and by the cover 72 positioned to oppose the lens 14 along the first partial length L1 of the housing 12. Along the second partial length L2 of the housing 12 not including the cover 72, the lower portion 16 of the housing 12 is defined by the lens 14 and by the surface 60 of the elongate base 40 positioned to oppose the lens 14.

The surface 60 and the cover 72 could have the same or similar geometries, although the surface 60 and the cover 72 of the LED-based light 10 can have differing geometries. The surface 60 may be configured as a substantially flat surface, including the opposing flanges 94 extending from the longitudinal edges of the surface 60, as well as the groove 102. When the substantially flat surface 60 is positioned to oppose the lens 14 with a substantially arcuate cross section, the housing 12 has the generally bow shaped cross section shown in FIG. 4 along the second partial length L2.

The cover 72 may have a substantially C-shaped cross section. The substantially C-shaped cross section of the cover 72 could be curvilinear, or as shown in FIG. 3, could include one or more flat surfaces, for instance, a number of adjoining flat longitudinally extending surfaces, such as the exemplary surfaces 24 and 26. The lower portion 16 of the housing 12 can be entirely defined by the substantially C-shaped cover 72 along the first partial length L1 of the housing 12, or the flanges 94 of the elongate base 40 can also form a contiguous portion of the lower portion 16 of the housing 12 along the first partial length L1 of the housing 12. When the substantially C-shaped cover 72 is positioned to oppose the lens 14 with a substantially arcuate cross section, the housing 12 has the substantially circular cross section shown in FIG. 3 along the first partial length L1.

The surface 60 and/or the cover 72 can have various geometries other than those shown in the figures and described herein. For example, the surface 60 could include arcuate or polygonal geometries. The surface 60 could also include structures for coupling with other components of the LED-based light 10, or could include structures for heat dissipation, for example. The addition of such structures could result in a surface 60 that remains substantially flat, or could result in a surface 60 that is not substantially flat. The surface 60 can extend a length of the housing 12, or, for example, could terminate at a point adjacent the cover 72. For the illustrated surface 60 extending a length of the housing 12, the exposed geometry of the surface 60 could be different from the geometry of the surface 60 enclosed by the cover. 72. The cover 72 could additionally have alternative geometries. The illustrated cover 72 includes, as a non-limiting example, a larger flat surface 24 at its apex compared to the exemplary surface 26 forming a portion of the side walls of 90 of the cover 72. The flat surface 24 could alternatively be enlarged, for example, to form a cover 72 with a substantially D-shaped cross section.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An LED-based light for replacing a fluorescent light in a light fixture, comprising:
an elongate housing, the housing having a first longitudinal portion with a first cross section and a second longitudinal portion adjoining the first longitudinal portion with a second cross section, wherein a shape of the first cross section is different from a shape of the second cross section, such that the housing includes at least one geometric asymmetry;
at least one LED arranged in the housing; and
a connector at and end of the housing configured for connection to a light fixture.

2. The LED-based light of claim 1, wherein the at least one geometric asymmetry is about a plane that is normal to a longitudinal axis of the housing and that passes through a midpoint of the housing.

3. The LED-based light of claim 1, further comprising:
power supply circuitry, the power supply circuitry housed within the first longitudinal portion and configured to supply power to the at least one LED.

4. The LED-based light of claim 3, the housing further comprising:
an elongate light transmitting lens, wherein a perimeter of the housing along both the first and second longitudinal portions is defined at least in part by the lens; and
a cover enclosing the power supply circuitry, wherein a perimeter of the housing along the first longitudinal portion but not along the second longitudinal portion is additionally defined at least in part by the cover.

5. The LED-based light of claim 4, further comprising:
a power supply assembly, the power supply assembly including the power supply circuitry and the cover, wherein the power supply assembly is selectively removably attached to a remainder of the housing.

6. The LED-based light of claim 1, wherein the first longitudinal portion has a substantially circular shaped cross section, and the second longitudinal portion has a substantially bow shaped cross section.

7. The LED-based light of claim 1, wherein the first and second longitudinal portions comprise substantially an entire length of the housing.

8. An LED-based light for replacing a fluorescent light in a light fixture, comprising:
an elongate base defining a first surface and an opposing second surface;
an LED circuit board supported on the first surface of the base, the LED circuit board including at least one LED;
a light transmitting lens attached to the base to enclose the LED-circuit board, the lens extending a substantial length of the base;
a power supply circuit board located adjacent the second surface of the base, the power supply circuit board configured to supply power to the at least one LED; and
a cover attached to the base to enclose the power supply circuit board, the cover extending only a partial length of the base.

9. The LED-based light of claim 8, wherein the base, the lens and the cover comprise a housing for the LED-based light, and wherein a perimeter of the housing is defined substantially by the lens and the cover along a first longitudinal portion of the housing, and substantially by the lens and the second surface of the base along a second longitudinal portion of the housing.

10. The LED-based light of claim 9, wherein the first longitudinal portion has a first cross section and the second longitudinal portion has a second cross section, and wherein a shape of the first cross section is different from a shape of the second cross section, such that the housing includes a geometric asymmetry about a plane that is normal to a longitudinal axis of the housing and that passes through a midpoint of the housing.

11. The LED-based light of claim 9, wherein the lens is arcuate and the cover is substantially C-shaped, such that the first longitudinal portion has a substantially circular shaped cross section.

12. The LED-based light of claim 9, wherein the lens is arcuate and the second surface of the base is substantially flat, such that the second longitudinal portion has a substantially bow shaped cross section.

13. The LED-based light of claim 9, wherein the first longitudinal portion adjoins the second longitudinal portion.

14. The LED-based light of claim 8, further comprising:
a connector at and end of the housing configured for connection to a light fixture.

15. The LED-based light of claim 8, further comprising:
a power supply assembly, the power supply assembly including the power supply circuit board and the cover, wherein the power supply assembly is selectively removably attached to the base.

16. An LED-based light for replacing a fluorescent light in a light fixture, comprising:
an elongate base;
an LED circuit board supported on the base, the LED circuit board including at least one LED;
a light transmitting lens attached to the base to enclose the LED-circuit board; and
a power supply assembly selectively removably attached to the base, the power supply assembly including power supply circuitry configured to supply power to the at least one LED.

17. The LED-based light of claim 16, the power supply assembly further comprising:
a connector configured for physical and electrical connection to a light fixture, the connector in electrical communication with the power supply circuitry.

18. The LED-based light of claim 16, the power supply assembly further comprising:
a cover enclosing the power supply circuitry, the cover extending only a partial length of the base.

19. The LED-based light of claim 18, wherein the base, the lens and the cover comprise a housing for the LED-based light, and wherein a perimeter of the housing is defined substantially by the lens and the cover along a first longitudinal portion of the housing, and substantially by the lens and the base along a second longitudinal portion of the housing.

20. The LED-based light of claim 19, wherein the lens is arcuate, wherein the cover is substantially C-shaped, such that the first longitudinal portion has a substantially circular shaped cross section, and wherein the base is substantially flat, such that the second longitudinal portion has a substantially bow shaped cross section.
